(19) United States
(12) Patent Application Publication
(10) Pub. No.: US 2007/0261198 A1
(43) Pub. Date: Nov. 15, 2007

(54) Clamping Connection Between the Clamping Shoe of a Roller and a Sliding Leaf

(75) Inventor: Thomas Vogler, Bad Salzuflen (DE)

Correspondence Address: COHEN, PONTANI, LIEBERMAN & PAVANE, 551 FIFTH AVENUE, SUITE 1210, NEW YORK, NY, 10176, US

(73) Assignee: Dorma GmbH + Co. KG, Ennepetal (DE)

(21) Appl. No.: 11/665,406

(22) PCT Filed: Sep. 9, 2005
(86) PCT No.: PCT/EP05/09687

§ 371 Date: Apr. 13, 2007

(30) Foreign Application Priority Data
Oct. 15, 2004 (DE) 10 2004 050 596.9

(51) Int. Cl. E05D 15/06

(52) U.S. Cl. 16/87 R

(57) ABSTRACT

A clamping shoe and sliding leaf combination including a clamping shoe having a clamping compartment; a sliding leaf having a plane surface and received in the clamping compartment; an adjusting screw received in the clamping shoe; and a clamping plate disposed in the clamping compartment, wherein movement of the adjusting screw relative to the clamping shoe causes the sliding leaf to be restrained in the clamping compartment and makes it possible to adjust a position of the clamping plate relative to the plane surface of the sliding leaf.

### DESCRIPTION

The invention relates to a clamping connection between the clamping shoe of a roller carriage and a sliding leaf, in particular a glass pane, which is suspended in a clamping compartment of the clamping shoe and restrained therein by means of clamping screws.

Generally, prior art clamping connections have a clamping shoe restraining the sliding leaf, which shoe, via a carrying bolt, is suspended in a roller carriage and connected thereto, which carriage is disposed above the clamping shoe and guided in a roller rail. As basically boreholes or openings in the sliding leaf are to be avoided, the adhesive friction force required for restraining the sliding leaf in the clamping shoe is obtained by a screw connection, which is disposed above the upper frontal face of the sliding leaf and presses the two cheeks of the flanks, which laterally delimit a groove shaped recess of the clamping shoe, non-positively against the plane surfaces of the sliding leaf. As a consequence, the disposition of the screw connection above the upper frontal face delimitation of the sliding leaf, on the one hand, inevitably results in a high construction height of the clamping shoe; and, on the other hand, on account of the above described lever ratios, a relatively important clamping force needs to be applied in the area of the screw connection, and the selection of an appropriate material for the above described clamping connection is required.

The object of the invention, in a clamping connection of the species mentioned in the introduction, is to prevent the loss of clamping force resulting from the above described lever ratios, and to minimize the required construction height for restraining a sliding leaf at the same time.

The invention solves the given problem with the teaching according to claim 1.

Accordingly, a clamping plate, which is adjustable against a plane surface of the sliding leaf by means of adjusting screws, is disposed in the clamping compartment of the clamping shoe.

This means that, while foregoing the lever arm, recognized as being disadvantageous, the force transfer of the adjusting screws is done directly into the sliding leaf, resulting in a considerable reduction of the required construction height. The torque applied by the adjusting screws is directly transformed into a resultant clamping force, whereby, at a comparable resultant clamping force, less stress needs to be transferred to the structural parts, such that a material of less stringent requirements, but still matching the stress can be used. In addition, with an appropriate shaping of the width of the groove-shaped clamping compartment, the inventive solution allows for using a scalable system, i.e. the restraining of sliding leaves without need for structural modification, particularly glass panes with different thicknesses, moreover, thickness tolerances do not matter anymore.

Further embodying features of the invention are subject matter of the dependent claims.

As the clamping compartments are formed as grooves open to below, the invention allows for disposing the upper frontal face of the sliding leaf adjacent the groove bottom, i.e. the sliding leaf can be introduced as far into the clamping compartment until its upper frontal face is located in the area of the groove bottom of the clamping compartment.

If the above described invention is advantageously usable also in such structural solutions where the clamping shoe is guided at a roller carriage by means of a carrying tenon, according to a particularly advantageous embodiment of the invention, it is proposed that the clamping compartment be integral with the roller carriage. The above mentioned feature results in a further considerable reduction of the required construction height. In this case, the clamping shoe and the roller carriage may form a structural unit, wherein in a further development, the clamping shoe has a lateral recess extending orthogonally to a plane surface of the sliding leaf and intended for the reception of a roller bracket carrying the carrying rollers, which, for adjusting purposes, is disposed height-adjustable at the clamping shoe.

It can be seen that, on account of the inventive solution, there is no loss of clamping force as a consequence of the constructional lever arms, which would result in a reduced clamping force compared to the applied torque, such that, with equal or higher clamping force, the construction height can be reduced considerably.

Hereinafter the invention will be explained based on a basic drawing representing the state-of-the-art and on an exemplary embodiment of the invention, wherein

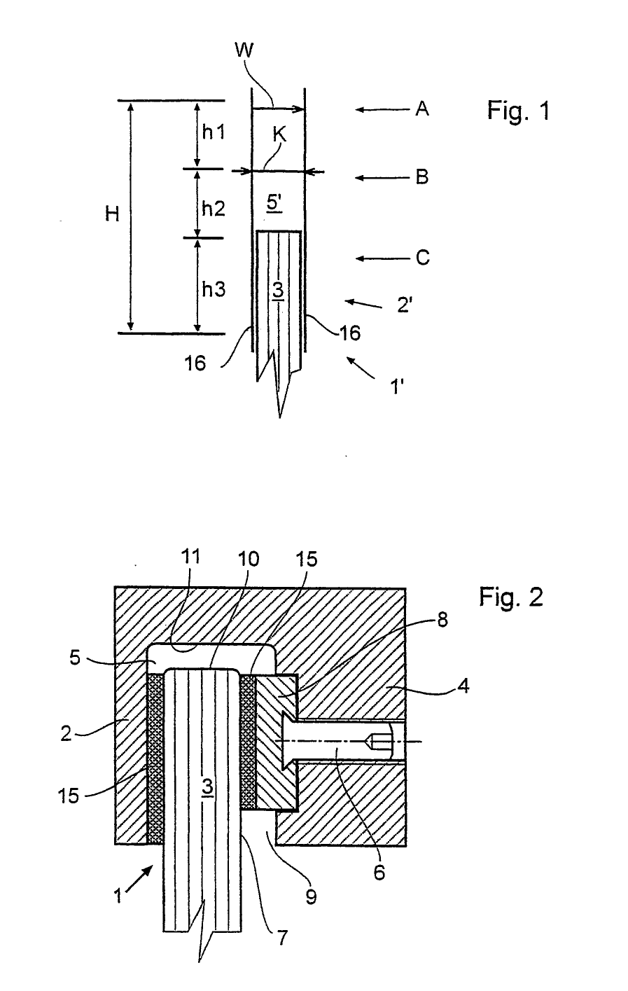

FIG. 1 shows a basic drawing explaining the state-of-the-art,

FIG. 2 shows a cross-sectional view of an inventive clamping connection, and

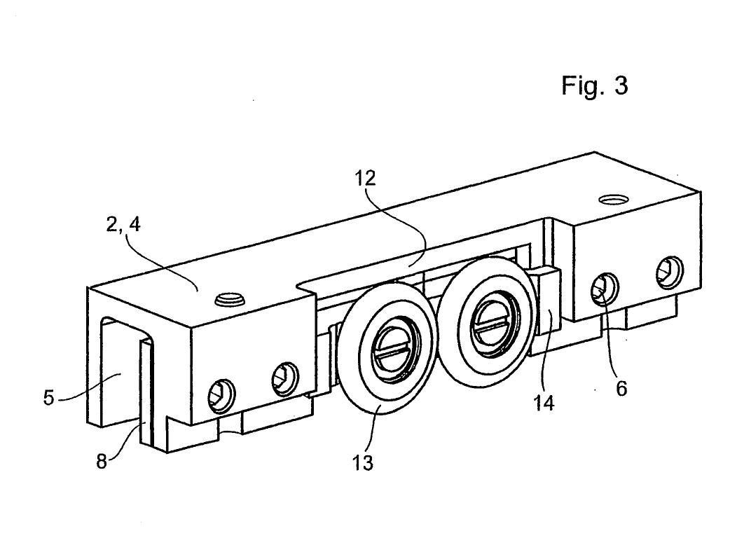

FIG. 3 shows a clamping connection integral with a roller carriage.

A clamping connection 1′ according to FIG. 1 shows a glass pane 3 restrained between side cheeks 16 of a clamping shoe 2′. A first functional area, identified by A, virtually forms a centre of rotation or an abutment W; a second functional area, identified by B, symbolizes the clamping location K determined by the screw connection, not referenced in detail, at which the torque is applied. The restraining of the glass pane 3 is realized in the third functional area C. Evidently, the distances h1, h2, and h3 sum up to an undesired high construction height H. It is further visible that a relatively important torque needs to be applied in the second functional area B, in order to reliably restrain the glass pane 3 in the area of the clamping compartment 5′.

In the clamping connection 1 according to FIGS. 2 and 3, a clamping shoe 2 likewise has a groove 5 open to below, which however may be formed wider in the exemplary embodiment, in order to be able to restrain glass panes 3 of different thicknesses. In the area of a clamping compartment 5, the glass pane 3 with its upper frontal face 10 is inserted approximately up to the area of a groove bottom 11 of the groove 9. This means that the torque applied by an adjusting screw 6 can be directly transferred to a plane surface 7 of the glass pane 3. Reference 15 identifies a glass protection, which, on the one end, abuts in the clamping shoe 2 and, on the other end, at the clamping plate 8 charged by the adjusting screw 6.

In this case, the glass protection 15 can be formed such that an additional friction and thus an increased holding force are generated.

According to the perspective illustration of FIG. 3, the clamping shoe 2 and a roller carriage 4 form a structural unit, i.e. the clamping shoe 2 is not suspended in a roller carriage nor guided therein via a carrying tenon.

For this purpose, the clamping shoe 2 has a lateral recess 12 for the reception of a roller bracket 14 carrying the carrying rollers 13. Also in the exemplary embodiment according to FIG. 3, the clamping plate 8, disposed in the clamping compartment 5, can be adjusted at the glass pane 3.

### LIST OF REFERENCES

1 clamping connection
1′ clamping connection
2 clamping shoe
2′ clamping shoe
3 glass pane
4 roller carriage
5 clamping compartment
5′ clamping compartment
6 adjusting screws
7 plane surface
8 clamping plate
9 groove
10 upper frontal face
11 groove bottom
12 lateral recess
13 carrying roller
14 roller bracket
15 glass protection
16 side cheeks
A functional area
B functional area
C functional area
h1 axial distances of the functional areas
h2 axial distances of the functional areas
h3 axial distances of the functional areas
H construction height
W abutment
K clamping location

1.-6. (canceled)

7. A clamping shoe and sliding leaf combination comprising:
a clamping shoe having a clamping compartment;
a sliding leaf having a planar surface, the sliding leaf being received in the clamping compartment and suspended from the clamping compartment;
an adjusting screw received in the clamping shoe; and
a clamping plate disposed in the clamping compartment,
wherein the sliding leaf is restrained in the clamping compartment by the adjusting screw, wherein a position of the clamping plate is adjustable relative to the planar surface of the sliding leaf by adjustment of the adjusting screw.

8. The combination of claim 7, wherein the clamping compartment is a groove open to one side of the clamping shoe and defining a groove bottom, the sliding leaf having a frontal face which is disposed adjacent to the groove bottom.

9. The combination of claim 7, further comprising a roller carriage, the clamping shoe and the roller carriage forming a structural unit.

10. The combination of claim 9, wherein the clamping shoe is integral with the roller carriage.

11. The combination of claim 9, wherein the clamping shoe has a lateral recess which extends orthogonally to the planar surface of the sliding leaf and is configured to receive a roller bracket carrying a carrying roller.

12. The combination of claim 11, wherein the roller bracket is adjustably received in the lateral recess of the clamping shoe.

13. The combination of claim 7, wherein the sliding leaf comprises a glass pane.

14. The combination of claim 13, wherein the clamping plate is disposed between the sliding leaf and the adjusting screw, the combination further comprising a glass protection element which is disposed between the sliding leaf and the clamping plate.
